(19) United States
(12) Patent Application Publication
(10) Pub. No.: US 2008/0210171 A1
(43) Pub. Date: Sep. 4, 2008

(54) Milking parlor

(76) Inventors: Thomas Mader, Rheda-Wiedenbruck (DE); Michael Heinrich, Lippstadt (DE); Otto Krone, Ibbenburen (DE); Peter Kaever, Trossingen (DE); Reinhard Frenser, Rheda-Wiedenbruck (DE); Magnus Wiethoff, Oelde (DE); Matthias Ahrens, Lippetal (DE); Klaus Fleck, Witten (DE)

Correspondence Address: SMITH LAW OFFICE, 440 SCIENCE DR., SUITE 302, MADISON, WI, 53711, US

(21) Appl. No.: 11/904,488

(22) Filed: Sep. 27, 2007

(30) Foreign Application Priority Data
Sep. 29, 2006 (DE) 10 2006 046 767.1

(51) Int. Cl. A01J 5/00

(52) U.S. Cl. 119/14.03; 119/14.04

(57) ABSTRACT

A milking parlor, milking module, and a closing unit comprising at least two closing members to optionally release or close a corresponding number of openings in a milking parlor floor which serves as a standing area. The closing members are disposed to be rotatable about a rotational axis at least between a closed position and an open position, wherein the open position allows at least one animal-related treatment means to be guided through said opening. Said rotational axis is disposed in a central region between the closing members.

### FIELD AND BACKGROUND OF THE INVENTION

The present invention relates to a milking parlor, a milking module for a milking parlor, and a closing means to close openings in the floor of a milking parlor. A milking parlor according to the present invention may be designed and provided for milking cows, ewes, goats, buffaloes, llamas, camels, dromedaries, yaks, elks, or horses or the like.

In the prior art, DE 10 2004 059 089 A1 has made known a milking installation with milking places where the milking unit is guided to and placed on the udder of the animal from beneath. For this purpose the milking parlor floor of a milking place is provided with an opening through which the individual teat cups can be guided upwardly through the platform. After the milking operation, the opening in the milking parlor floor is covered under a cover plate so as to protect the milking unit from being damaged as the animals enter and leave and to protect the animals to be milked. To entirely release or re-close the opening in the milking parlor floor, the entire cover plate is laterally pivoted 180° in the horizontal direction across the milking parlor floor about a vertical pivot axis disposed at the edge of the opening. The wide pivoting movement of the cover plate requires much space. No objects can be positioned within the pivoting range which would impede movement of the cover plate. Since during pivoting the cow to be milked is already standing on the milking parlor floor, the available space is considerably reduced due to the positions of the animal's legs.

According to DE 10 2004 059 089 A1, the opening in the milking parlor floor is aligned perpendicularly beneath the udder of an animal to be milked to minimize the distance for placing the teat cups on the teats of the animal to be milked. For this reason the cover place can only pivot towards the front end of the cow since pivoting movement towards the rear would be impeded by the rear legs of the cow.

Positioning the teat cups beneath the udder of the animal to be milked is less than optimal in view of ergonomics, in particular if placing occurs from the rear through the legs because the milker may have to grasp the teat cups with his arms outstretched and then shift them upwardly for placing. Such raising of the teat cups is strenuous for the milker due to the inconvenient working angle.

However, a system according to DE 10 2004 059 089 A1 does not allow any improvements in geometry since the space required for pivoting is not available because the legs of the animal to be milked must be taken into account.

### SUMMARY OF THE INVENTION

Therefore it is the object of the invention to provide a closing unit, a milking module, and a milking parlor, wherein the opening in a milking parlor for guiding through animal-related means is closed by a means requiring less space than is the case in the prior art.

The closing unit according to the invention comprises at least two closing members to optionally release or close a corresponding number of openings in a milking parlor floor which serves as a standing area. The at least two closing members are positioned to be rotatable about a rotational axis at least between a closed position and an open position, wherein the open position allows at least one animal-related treatment device to be guided through said opening. Said rotational axis is positioned in a central region between the closing members.

The closing unit according to the invention has many advantages. A space-saving operation is ensured by way of providing a rotational axis positioned in a central region around which the closing members are disposed so as to rotate about it. A rotation around a central rotational axis results in that during opening and closing as well as in an open state, the space required is considerably reduced compared to the prior art. It is conceivable that no additional space is required for the rotational movement since said rotational movement occurs around a centrally positioned axis, not around an axis positioned at the edge.

There is the further considerable advantage that positioning the openings in the milking parlor floor is much more flexible since the small additional space requirement allows to position the openings near the edge of the milker's pit. This allows an increase in work ergonomics which considerably contributes toward an increase in productivity.

Thus the openings cannot only be positioned in the longitudinal direction of a typical cow to be milked, between the front ant the rear legs, but in particular between or even behind the rear legs. Since no additional or only little additional space is required for opening and closing, such a configuration can be realized.

It is another advantage that by way of disposing multiple openings and corresponding closing members, each opening may be provided to be comparatively small so as to minimize the risk of injury to the animals even if an animal should tread on such opening when open since the diameter of the openings may be selected to be small enough to prevent an average animal from sinking into said opening with a hoof or a leg.

Moreover, the invention allows for a particularly simple function.

The term “closing” in the sense of this application is understood to mean that the opening is covered or reduced in size so as to substantially rule out the risk of injury in a closed state. This means that when closed, the opening is either entirely closed or it is covered or closed in such a way that the hooves or the legs of a cow in the case of a milking parlor for cows, or the hooves of a goat or a sheep etc. in the case of a milking parlor for said animals, cannot sink in or be squeezed in.

The closing members can in particular be moved by rotary movement by a predetermined angle from a closed position to an open position.

A preferred specific embodiment of the invention provides for the closing unit to comprise part of the milking parlor floor; said closing unit may for example be configured as a module which is a prefabricated element and thus mounted to the milking parlor. The milking parlor may be provided with a recess for the closing unit to be inserted during assembly. Said closing unit will then terminate upwardly in the corresponding portion of the milking parlor floor.

For milking ewes or goats or other animals having two teats only, two openings in the milking parlor floor are sufficient as a rule. For milking cows, two more openings, i.e. four openings in total, may be provided. Or else, two closing units having two closing members each with a total of four openings may be provided.

According to an advantageous specific embodiment of the invention, a rotational movement about a predetermined angle leads to at least one of the closing members to be displaced in height. Height displacement occurs in particular in parallel relative to the central or the center rotational axis. Said central rotational axis is in particular provided on, or configured as, a vertical guide.

Height displacement occurs in particular through transforming of the rotational movement into a linear movement by means of a crank or con-rod means or by means of a slider crank drive, a rotation vibrator, an eccentric drive, or a slider control.

What is particularly preferred is a helical movement wherein rotational movement will generate a vertical movement. This may be realized by a kind of thread provided at the milking parlor floor and the closing members. It is also possible and preferred to employ a slider guide wherein the closing members are vertically guided during rotational movement.

The rotational angle between the open and the closed position preferably equals a base rotational angle plus a multiple of 90 degrees with the base rotational angle preferably being between 25 and 65 degrees, in particular between 30 degrees and 60 degrees and particularly preferred, 45 degrees. These data must in particular take into account a deviation of +/−10 degrees. The entire rotational angle is in particular smaller than 360°, it may, however, be larger.

All of the configurations described above may provide for a teat cup receiving means beneath the standing area for receiving and holding and/or cleaning the teat cups. At least one teat cup receiving means may be provided at the underside of at least one closing member, comprising at least one fluid line which may serve to supply or discharge fluid. The teat cup receiving means may in particular be configured as a kind of rinsing adapter to receive the teat cup in the rest position so as to perform intermediate rinsing, cleansing and/or disinfection of the teat cup. The rotational axis may comprise at its interior one or multiple supply and/or discharge lines for fluids.

Preferred specific embodiments of the closing unit according to the invention provide a body or a retaining means, relative to which the closing members are positioned substantially symmetrically.

In a closing unit for milking installations e.g. for cows, said four closing members or four openings preferably outline a square or a rectangle or a trapezoid with the rotational axis of the closing members provided approximately at the center. Where one common retaining unit is provided, it will as a rule form or receive the rotational axis.

In the presentation position an operator can grasp the treatment device or unit and move it toward the teats of the animal to be treated.

To avoid that the closing members open inadvertently, an angled locking device may be provided at the retaining unit, or an angled locking device may be provided at one or more individual closing members, so as to reliably prevent the closing members from inadvertently opening or closing.

Preferred embodiments of the invention provide, if a slider control is employed, a dead point on the slider mechanics to be overcome for opening or closing so as to avoid inadvertent opening.

According to another configuration according to the invention the closing unit comprises a rotatable covering means which comprises a number of through holes substantially positioned inside a circle. Between the through holes the covering means itself forms a closing member or it is in itself a closing member such that in a first predetermined angle device, the openings in the milking parlor floor serving as a standing area are aligned flush with the through holes provided in the covering means, and in a second predetermined angular position the through holes provided in the standing area are closed by the covering means.

The through holes may in particular be arranged in the shape of a circle, rectangle, square or trapezoid or the like.

The covering means is in particular configured as a disk and may comprise a central bore at which it is received to be rotatably supported.

Preferably four through holes offset by approximately 90 degrees are provided having a diameter that is matched to the diameters of the treatment devices or the teat cups.

In all of the configurations of the invention described above, one or each opening in the standing area is a maximum of less than 10 cm in width, in particular less than 8 cm.

The milking module according to the invention comprises at least one standing area which serves as part of a milking parlor floor, with at least two openings provided therein for animal-related treatment devices to be guided through the standing space from beneath. A number of closing members corresponding at least to the number of openings is provided which by means of a rotational movement about a rotational axis positioned in a center region between the closing members can be transferred from an open position to a closed position to optionally release or close the openings.

The milking module according to the invention also has many advantages and due to its small space requirement it allows variable uses with the openings open and closed.

Preferably the individual closing members are positioned on one common closing unit. The closing unit is preferably positioned to be rotatable about a central, vertical rotational axis provided at the center of the closing members.

In all of the configurations rotational movement will displace the closing members in height. The closing members may be positioned in the open position beneath, or else above the standing area. It is also conceivable that part of the closing members are positioned in the open position above the standing area and another part of the closing members in the open position, beneath the standing area.

When the closing members in the open condition are positioned above, they are in particular directly or indirectly supported on the standing area to allow an optimal dispersion of a possible weight load.

The milking module may be provided with a treatment device that is taken from a group comprising, teat cups, teat cleaning units or devices, pretreatment units or devices and posttreatment units or devices and the like. It is also conceivable to provide multiple like or different treatment units.

In a preferred specific embodiment of the invention the milking module comprises at least two treatment devices and in particular at least two teat cups which can be moved through at least one elevating means from a rest position beneath the standing area to a presentation position provided at least in part above the standing area. The elevating means can in particular be operated automatically, being controlled by a control means.

The milking parlor according to the invention comprises at least one milking place including, a milking parlor floor and at least two openings provided in the milking parlor floor for animal-related devices or units to be guided through. A number of closing members corresponding at least to the number of openings is provided which by means of a rotational movement about a rotational axis positioned in a center region between the closing members can be transferred from an open position to a closed position to optionally release or close the openings.

It is a considerable advantage of the milking parlor according to the invention that the at least two openings provided in the milking parlor floor can be opened and re-closed by way of a rotational movement around a central axis.

Due to the rotational axis provided centrally between the closing members, the space required for opening and closing the closing members is small. In this way the positions of the openings can be chosen more freely and a structure convenient in terms of ergonomics is in particular possible.

Preferably at least one treatment device is provided which is taken from a group comprising, teat cups, cleaning devices, premilking cups, strip yield devices, teat care devices, pretreatment devices and posttreatment devices and the like.

In particular at least one treatment device or treatment device is provided which can be displaced via an elevating means from a rest position beneath the standing area to a presentation position at least in part above the standing area. Preferably at least two treatment devices or units configured as teat cups are provided which can be displaced from the rest position to the presentation position.

In all of the configurations it is preferred that an operator can grasp the treatment device in the presentation position and manually bring it to the teats of the animal to be treated.

In all of the embodiments preferably at least one rinsing adapter is provided to rinse and/or cleanse and/or disinfect at least one treatment device.

Preferably the treatment device can be brought to the rinsing adapter automatically to ensure automatic rinsing in periodic or freely adjustable intervals.

By means of the invention, a simple closing mechanism for the openings in a milking parlor floor before and after milking is provided. The storing area of the milking unit is protected from contamination through the closing or covering means. The closing means ensures reliable operation, offering a high level of safety from injuries. The space requirement is in particular low and the closed floor can be uniformly plane so as to not unsettle the animals when entering and leaving the milking parlor.

The individual closing members are in particular supported by one common carrier device e.g. in the shape of a carrier frame which pivotally receives the closing members.

In a specific embodiment the closing unit is pivoted and simultaneously guided in a guide so as to additionally effect a vertical displacement of the closing unit. This may be realized by a kind of thread wherein the closing unit comprises an inner thread interacting with an outer thread of a central supporting pin or the like. Pivoting about the predetermined rotational angle causes the closing unit with the closing members to be displaced upwardly or downwardly by a specific amount.

The thread pitch is configured such that at this rotational angle the vertical displacement is greater than the height of the respective milking parlor floor. This means that the rotational movement leads to a vertical displacement such that the four closing members above or beneath the milking parlor floor are offset at angles relative to one another and displaced into a milking position in which the openings in the milking parlor floor are released.

The rotational movement for opening and closing may in each case be realized by way of a vacuum or compressed air cylinder, by winch traction or a separate electric motor or the like.

Any inadvertent opening may in any case be prevented by way of a rotation lock which needs to absorb only small forces e.g. corresponding to the thread pitch even in case of heavy loads from above. All of the solutions therefore achieve a high level of security.

In the prior art, however, in the open and the closed condition the lid is positioned on the top edge of the milking parlor floor so as to make the floor uneven for the animals. If an animal treads in front of a closed lid, the lid might be displaced and thus the opening released, involving a high risk of injury. In the present case, the closed condition allows to achieve a substantially plane surface so as to eliminate such risk.

In all of the cases the rotational axis is particularly preferably provided centrally between the closing members of the closing unit. This means that the rotational axis for rotating the closing members, in case when for example two closing members are arranged, is preferably precisely in the center between the two closing members while, given e.g. four closing members, the rotational axis is preferably arranged on the intersection point of the diagonal lines.

Further advantages and possibilities for application follow from the embodiments described below with reference to the figures.

### BRIEF DESCRIPTION OF THE DRAWINGS

FIG. 1 a schematic top view of a milking place according to the present invention;

FIG. 2 a general, highly simplistic sectional side view of the milking place according to FIG. 1;

FIG. 3 a first embodiment of a closing mechanism for the milking place according to FIG. 1 in a closed state;

FIG. 4 the embodiment according to FIG. 3 in an opened state;

FIG. 5 a second embodiment of a closing mechanism in a closed state;

FIG. 6 the embodiment according to FIG. 5 in an opened state;

FIG. 7 a third embodiment of a closing mechanism according to the invention in a schematic top view; and

FIG. 8 the embodiment of the closing mechanism according to FIG. 7 in a schematic, sectional side view.

### DETAILED DESCRIPTION OF THE PREFERRED EMBODIMENTS

Like or similar parts in the different embodiments are provided with the same reference numerals.

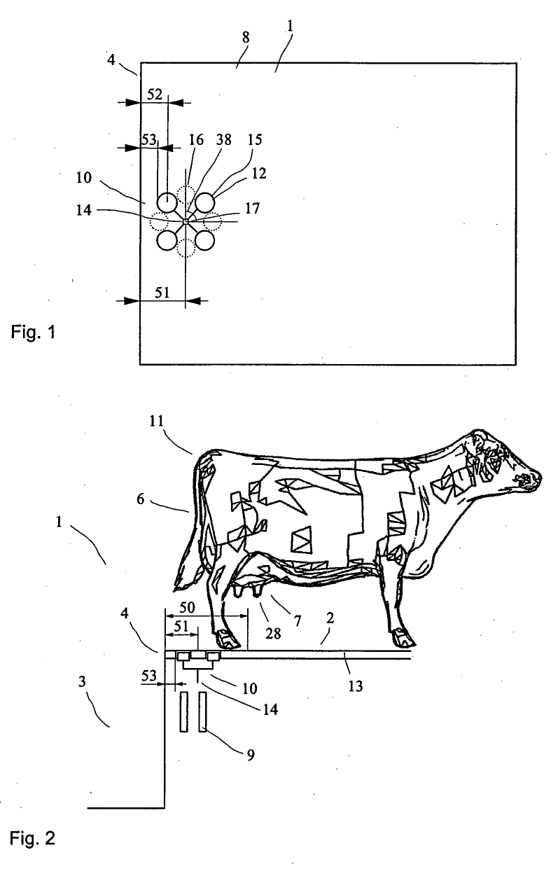

The FIGS. 1 through 3 schematically illustrate a first embodiment of a milking parlor 1 according to the invention. FIG. 1 shows a highly schematic top view of a milking place 8 of a milking parlor 1, which is presently configured e.g. as a side by side milking parlor in which the individual teat cups 9 are manually placed from the rear through the legs of the cow. FIG. 2 illustrates a schematic, sectional side view.

The individual teat cups 9 are guided upwardly through openings 5 in the standing area 2 of the milking place 8 from below through the milking parlor floor 13 and then manually placed by the milker on the teats 28 of the cow 6. For each teat there is provided a separate opening 5 for an individual teat cup 9 to be guided through.

To largely avoid contamination of the teat cups 9 and to rule out a risk of injury to the animals in changing places, a closing unit 10 is provided, comprising four separate closing members 12 extending symmetrically outwardly from a centrally positioned rotational axis 14, such that the presently four closing members 12 are arranged in a circle around the rotational axis 14 which is disposed in a central region 17. Herein the closing members 12 also extend on a circle around the rotational axis 14. The individual closing members 12 are fixedly connected with the closing unit 10 such that a rotational movement of the closing unit 10 around the rotational axis 14 will result in synchronous rotation of all of the four closing members 12.

In FIG. 1 the open position 16 is illustrated in dashed lines where the closing members are rotated relative to the closed position 15 illustrated in a solid line by a rotational angle 38 of approximately 45°.

The distance 51 of the rotational axis 14 from the edge 4 of the milker pit 3 is considerably smaller than the distance 50 of the udder 7 from the edge 4 of the milker pit 3. This allows an ergonomic working position for the milker who grasps the teat cups 9 protruding from the openings 5, lifts and then places them on the teats 28 of the cow 6.

Since the distance of the central rotational axis 14 from the edge of the milker pit is small, the milker can grasp the individual teat cups 9 with his arms bent and in a combined straightforward and vertical movement, place them on the teats 28 of the cow 6. The strain on the milker is small since when grasping and lifting the teat cups his position will be ergonomic.

The distance 53 of an opening 5 from the edge of the milker pit is short, being in particular in the range between approximately 5 cm and 25 cm.

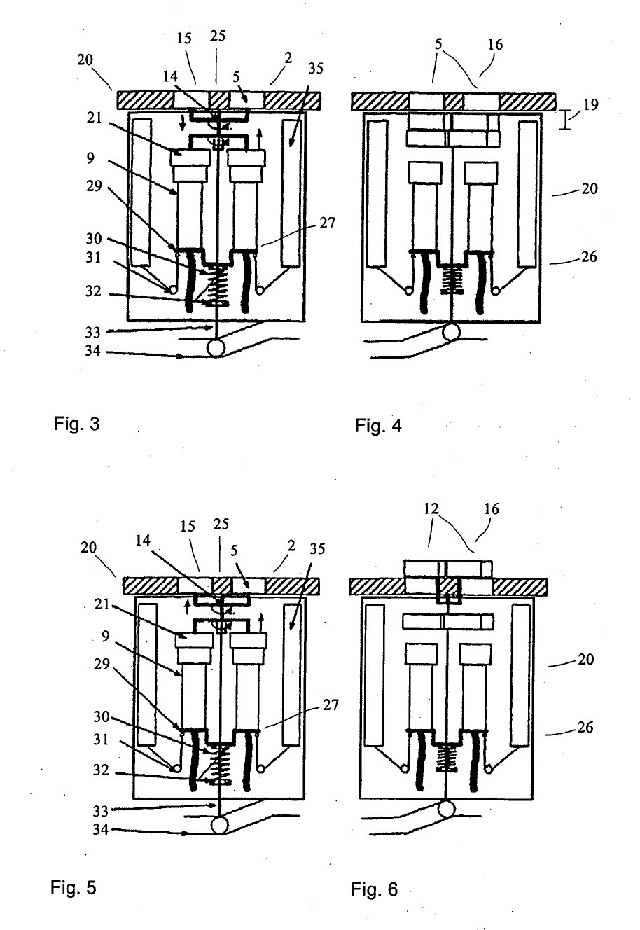

The FIGS. 3 and 4 illustrate the milking module 20 with the closing unit 10 of the milking parlor 1. The FIG. 3 illustrates the closed position 15 and FIG. 4, the open position 16, in which the four openings 5 are open for the teat cups 9 to be displaceable from the rest position 26 arranged beneath the standing area 2 to the presentation position 37 (see FIG. 8) part of which is provided above the standing area 2.

Opening and closing the closing unit 10 of the milking module 20 in this embodiment occurs through a lifting slider 34 connected with the closing unit 10 by means of a lifting plunger 33. The slider guide elevates the lifting plunger 33 and biases the spring of the energy store 30 while the closing members 12 of the closing unit 10 simultaneously rotate about a 45 degree angle, such that in the embodiment of FIGS. 3 and 4 the closing members 12 are sunk on a helical path beneath the standing area 2 and the openings 5 in the standing area are released.

Now, after activating the electro-mechanical locking screw 32, the teat cups 9 which are positioned precisely under the openings 5 can, by means of the energy stored in the spring 30, be displaced upwardly to the presentation position, where the milker can grasp them and place them on the teats 28 of the animal 6 standing in the milking position 11.

The end of the milking operation is in particular initiated for each teat individually as the milk flow intensity (for each teat individually or as the total flow) drops. As the flow drops beneath a specific threshold value, individual or all of the teat cups 9 are removed. Presently, the vacuum cylinders 35 are activated which are individually provided for each teat and connected with the teat cups 9 via ropes rerouted at deflections 31.

By way of activating of a vacuum cylinder 35 the corresponding teat cup 9 is removed from the teat 28 of the animal to be milked 6 and the teat cup 9 falls into the teat cup receiver 27.

As the milking operation has finished for all of the four teats, the openings 5 are re-closed by the closing unit 10. The teat cups 9 are inserted in the rinsing adapter receiver 21 disposed on the underside of the closing unit 10, where the teat cups 9 are automatically rinsed. Cleansing and/or disinfection of the teat cups may occur at regular or irregular intervals.

The exemplary embodiment according to the FIGS. 3 and 4 provides for the weight load of a cow acting on the closing unit 10 when it steps on the closing unit 10, to be dissipated downwardly through the lifting plunger 33. Large forces can be absorbed and dissipated in this way.

The FIGS. 5 and 6 illustrate a variant of the milking module 20 where the closing unit 10 also comprises four closing members 12. The closing unit 10 in turn can be transferred from the closed position into the open position by means of a slider control. The individual closing members 12 are displaced about a 45° angle.

Other than in the milking module according to FIGS. 3 and 4, the closing members 12 are moved vertically upwardly for opening such that in the opened state the closing members 12 are supported downwardly on the standing area 2 of the milking place 8. The closing members 12 lying on top of the standing area can support the posture of a cow with legs spread apart, since cows do not like standing on an uneven surface.

The exemplary embodiment according to the FIGS. 5 and 6 may provide at the bottom edge of the openings 5, a protrusion extending radially inwardly which may serve for one as a seal and for another to prevent, even with large forces applied from above, the closing members 12 from shifting downwardly through the holes 5.

Otherwise the further particulars and the functional principle largely correspond to the exemplary embodiment illustrated in the FIGS. 3 and 4.

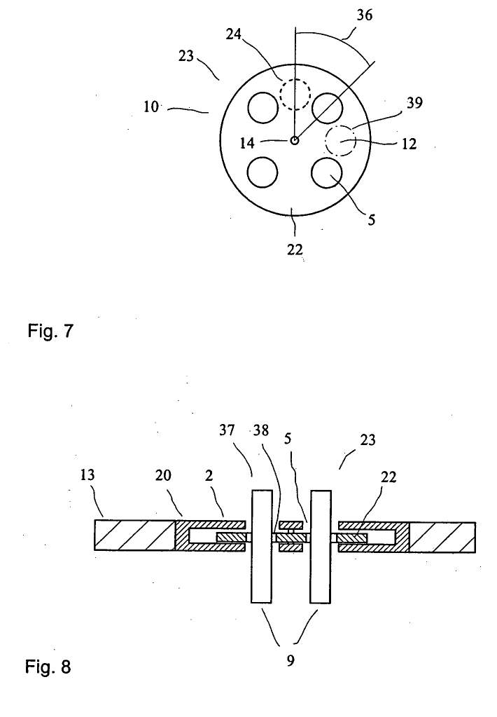

The FIGS. 7 and 8 illustrate another exemplary embodiment with a closing unit 10 for a milking parlor 1. This closing unit 10 substantially consists of a round disk 22 rotatably received in the standing area 2 of the milking parlor 1.

In the disk 22 supported to rotate centrally around the rotational axis 14, four through holes 5 are provided arranged symmetrically through which, at a suitable angular position, the teat cups 9 positioned beneath the standing area 2 can be guided upwardly to the presentation position 37.

A rotation about an angle 36 of 45° brings the openings 38 in the disk 22 into alignment with the corresponding openings 5 in the standing area 2 such that through holes are provided for the individual teat cups 9 to be guided through and thereafter manually placed on the teats 28 by the milker. This is the angular position 23 illustrated in the FIGS. 7 and 8. In the angular position 24 the opening 5 is closed (see FIG. 7).

After termination of the milking operation the teat cups 9 are retracted into corresponding teat cup receivers 27 and the disk 22 is rotated about the rotational axis 14 from the open position to the closed position. In the closed position the disk material between the openings 38 serves as a closing member 12 to cover the opening 5 extending in the standing area 2 such that the dash-dotted circle 39 illustrated in the FIG. 7 serves as a closing member 12.

The standing area 2 which in the exemplary embodiment according to the FIGS. 7 and 8 is not quite plane causes the cow 6 to leave the openings 5 free.

1. A closing unit comprising: a plurality of closing members, to optionally open and close a corresponding number of openings in a milking parlor floor standing area; a rotational axis about which the closing members rotate between a closed position and an open position; wherein in the open position, an animal-related treatment device can be guided through the opening, and wherein the rotational axis is arranged in a central region between the closing members.

2. The closing unit according to claim 1 wherein the closing members define at least part of the milking parlor floor.

3. The closing unit according to claim 1, wherein four closing members are provided.

4. The closing unit according to claim 1 wherein the closing members rotate in an angle between the open position and the closed position and the angle equals a base rotational angle plus a multiple of about 90 degrees.

5. The closing unit according to claim 4 wherein the base rotational angle is between 25° and 65°.

6. The closing unit according to claim 1 and further comprising: a height displacer joined to at least one of the closing members, wherein the closing member changes height as it rotates.

7. The closing unit according to claim 1 and further comprising: a vertical guide in which the rotational axis is disposed.

8. The closing unit according to claim 1 and further comprising: a translator for transforming rotation of a closing member into a linear movement of the closing member.

9. The closing unit according to claim 1 and further comprising: a slider guide for transforming rotation of a closing member into linear movement of the closing member.

10. The closing unit according to claim 1 and further comprising: a teat cup receiver disposed below a closing member.

11. The closing unit according to claim 10 wherein the teat cup receiver comprises at least one fluid line.

12. The closing unit according to claim 1 and further comprising a retainer, relative to which the closing members are positioned substantially symmetrically.

13. The closing unit according to claim 1 and further comprising: at least one angled locking device.

14. The closing unit according to claim 1 and further comprising: a rotatable cover having a plurality of through openings arranged in a circle, between which the cover forms the closing members such that in a first predetermined angular position the openings in the milking parlor floor are substantially aligned with the through openings in the cover and in a second predetermined angular position the cover closing members are at least partially aligned with the openings in the milking floor.

15. The closing unit according to claim 14 wherein each through opening is a maximum of less than 10 cm in width.

16. A milking module having a standing area which serves at least as part of a milking parlor floor and comprising: at least two openings through which animal-related treatment devices are guided; a plurality of closing members corresponding at least to the number of openings, wherein the closing members can be transferred between an open position and a closed position; and a rotational axis arranged in a central region between the closing members and about which the closing members rotate so as to optionally open or close the openings.

17. The milking module according to claim 16, wherein the closing members are provided on one common closing unit.

18. The milking module according to claim 16, and further comprising: a height displacer joined to the closing members.

19. The milking module according to claim 18, wherein the closing members are arranged in the open position when beneath the standing area.

20. The milking module according to claim 18, wherein the closing members are arranged in the open position when above the standing area.

21. The milking module according to claim 17, and further comprising: a slider guide operatively joined to the closing unit.

22. The milking module according to claim 16, and further comprising: a treatment device of a type selected from the group consisting essentially of: teat cups, teat cleaning devices, pretreatment devices, and post-treatment devices.

23. The milking module according to claim 16 and further comprising: at least two teat cups; and an elevator for moving the teat cups between a rest position beneath the standing area to a presentation position at least partially above the standing area.

24. A milking parlor comprising: at least one milking place; a milking parlor floor; at least two openings in the milking parlor floor through which animal-related devices are guided; and a plurality of closing members corresponding to the number of openings for movement between an open position and a closed position by way of rotational movement about a rotational axis arranged in a central region between the closing members so as to optionally release open or close the openings.

25. The milking parlor according to claim 24, wherein at least one treatment device is provided which is selected from a group consisting essentially of: teat cups; cleaning devices; pre-milking cups; strip yield devices; teat care devices; pretreatment devices; and post-treatment devices.

26. The milking parlor according to claim 24 wherein at least two treatment devices are provided which can be moved via an elevator from a rest position beneath the standing area to a presentation position provided at least in part above the standing area.

27. The milking parlor according to claim 24, wherein the treatment device in the presentation position can be grasped by an operator and brought to the teats of the animal to be treated, and wherein the distance of the at least one treatment device from an edge of a milker pit is shorter than the distance of the udder of a typical animal from the edge of the milker pit in a milking position.

28. The milking parlor according to claim 24, wherein the treatment device can be manually brought from the presentation position to the teat of an animal to be treated.

29. The milking parlor according to claim 24, and further comprising: a rinsing adapter rinsing at least one treatment device.
